(19) United States
(12) Patent Application Publication
(10) Pub. No.: US 2021/0179062 A1
(43) Pub. Date: Jun. 17, 2021

(54) HYBRID VEHICLE AND METHOD OF CONTROLLING THE SAME

(71) Applicants: HYUNDAI MOTOR COMPANY, SEOUL (KR); KIA MOTORS CORPORATION, SEOUL (KR)

(72) Inventor: Heeyun Lee, Seoul (KR)

(21) Appl. No.: 16/842,168

(22) Filed: Apr. 7, 2020

(30) Foreign Application Priority Data
Dec. 13, 2019 (KR) 10-2019-0166232

(51) Int. Cl. B60W 20/13; B60W 30/188

(52) U.S. Cl. CPC B60W 20/13; B60W 2050/0026; B60W 30/188

(57) ABSTRACT

The disclosure relates to a hybrid vehicle and a method of controlling of the hybrid vehicle, and an aspect of the disclosure is to generate optimal vehicle control values through learning using Q-learning technique of reinforcement learning in the field of machine learning based on vehicle state information. The method of controlling the hybrid vehicle includes obtaining vehicle state information including battery SOC information, engine on/off information, demand power, vehicle speed information, and fuel consumption information; creating a vehicle model information map using the vehicle state information; creating a Q value table based on the vehicle model information map; and calculating power distribution control values of an engine and a motor through reinforcement learning based on the Q value table.

### CROSS-REFERENCE TO RELATED APPLICATION(S)

This application is based on and claims priority under 35 U.S.C. § 119 to Korean Patent Application No. 10-2019-0166232, filed on Dec. 13, 2019 in the Korean Intellectual Property Office, the disclosure of which is incorporated by reference in its entirety.

### TECHNICAL FIELD

The disclosure relates to a vehicle, and more particularly, to a hybrid vehicle equipped with an engine and a motor.

### BACKGROUND

A hybrid vehicle uses two or more different types of power sources. For example, a vehicle equipped with an engine using fossil fuels and a motor using electric energy is a representative hybrid vehicle. In the hybrid vehicle, a power distribution control technology that appropriately distributes the power of the engine and the motor required for driving the hybrid vehicle according to a driving situation of the hybrid vehicle is very important for improving fuel efficiency.

The power distribution control technology of mass-production hybrid vehicles mainly uses a rule-based control strategy. The rule-based control strategy uses the power source in a high efficiency range and maximizes energy recovery due to regenerative braking by controlling the engine on/off and determining an operation time of each of the engine and the motor according to a certain rule, and improves fuel economy of the vehicle by controlling a state of charge of a battery according to the driving situation of the vehicle.

In addition to the rule-based control strategy commonly used in the mass-production hybrid vehicles, an optimization-based control strategy based on an optimization theory has been widely studied. Optimization-based control strategies, such as Dynamic Programming Principle and Equivalent Consumption Minimization Strategy, are used directly and indirectly to establish and formulate rules for the rule-based control strategy of the mass-production hybrid vehicles.

However, since the existing rule-based control strategies are constructed based on heuristics, a decision-making method that improvises/intuitively determines/selects only limited information, rather than a rigorous analysis of a particular issue or situation, further optimization is needed depending on a structure and driving environment of a powertrain of the hybrid vehicle. In addition, the existing optimization-based control strategy has a disadvantage in that it is difficult to use for real-time control due to a large computational load. In addition, the existing rule-based control and optimization-based control strategies have limitations in operating variable control logic to reflect the aging and environmental changes of hybrid vehicles.

### SUMMARY

Therefore, an aspect of the disclosure is to generate optimal vehicle control values through learning using Q-learning technique of reinforcement learning in the field of machine learning based on vehicle state information.

Additional aspects of the disclosure will be set forth in part in the description which follows and, in part, will be obvious from the description, or may be learned by practice of the disclosure.

In accordance with an aspect of the disclosure, a method of controlling a hybrid vehicle includes obtaining vehicle state information including battery SOC information, engine on/off information, demand power, vehicle speed information, and fuel consumption information, creating a vehicle model information map using the vehicle state information, creating a Q value table based on the vehicle model information map, and calculating power distribution control values of an engine and a motor through reinforcement learning based on the Q value table.

The reinforcement learning based on the Q value table may be configured to calculate the power distribution control values using the vehicle state information generated in two consecutive periods as state and reward values, respectively.

The method may further include updating the vehicle model information map to reflect change contents in the vehicle state information, updating the Q value table to reflect update contents of the vehicle model information map, and performing calculation of the power distribution control values reflecting the changed contents of the vehicle state information by performing the reinforcement learning based on the updated Q value table.

The power distribution control values are values for minimizing energy consumption of the engine and the motor while satisfying the demand power.

In accordance with another aspect of the disclosure, a hybrid vehicle includes a vehicle state information obtaining device configured to obtain vehicle state information including battery SOC information, engine on/off information, demand power, vehicle speed information, and fuel consumption information; and a controller configured to create a vehicle model information map using the vehicle state information, to create a Q value table based on the vehicle model information map, and to calculate power distribution control values of an engine and a motor through reinforcement learning based on the Q value table.

The reinforcement learning based on the Q value table may be configured to calculate the power distribution control values using the vehicle state information generated in two consecutive periods as state and reward values, respectively.

The controller may be configured to update the vehicle model information map to reflect change contents in the vehicle state information, to update the Q value table to reflect update contents of the vehicle model information map, and to perform calculation of the power distribution control values reflecting the changed contents of the vehicle state information by performing the reinforcement learning based on the updated Q value table.

The power distribution control values are values for minimizing energy consumption of the engine and the motor while satisfying the demand power.

The controller may include a power distribution calculator, a Q value table calculator, a vehicle model information map, and a vehicle model information map updater.

The power distribution calculator may be configured to calculate the power distribution control values of the engine and the motor based on the vehicle state information using the Q value table of the Q value table calculator.

The Q value table calculator may be configured to update values of the Q value table according to a predetermined algorithm.

The vehicle model information map may include a battery SOC information table and an engine fuel consumption information table.

The battery SOC information table may be configured to store relationship data between the battery SOC information, the demand power, and a battery SOC output according to the vehicle speed.

The engine fuel consumption information table may be configured to store relationship data between an engine fuel consumption amount determined according to the demand power, the vehicle speed, and the engine on/off information.

The vehicle model information map updater may be configured to update data of the vehicle model information map using the changed driving information of the hybrid vehicle and the changed vehicle state information.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a control system of a hybrid vehicle according to exemplary embodiments of the disclosure.

FIG. 2 is a view illustrating a concept for generating an optimal power distribution control value of a hybrid vehicle according to exemplary embodiments of the disclosure.

FIG. 3A is a view illustrating a four-dimensional lookup table of an SOC information table stored in a vehicle model information map of a controller according to exemplary embodiments of the disclosure.

FIG. 3B is a view illustrating a four-dimensional lookup table of an engine fuel consumption information table stored in a vehicle model information map of a controller according to exemplary embodiments of the disclosure.

FIGS. 4A and 4B are views illustrating a control method for generating an optimal power distribution control value of a hybrid vehicle according to exemplary embodiments of the disclosure.

### DETAILED DESCRIPTION

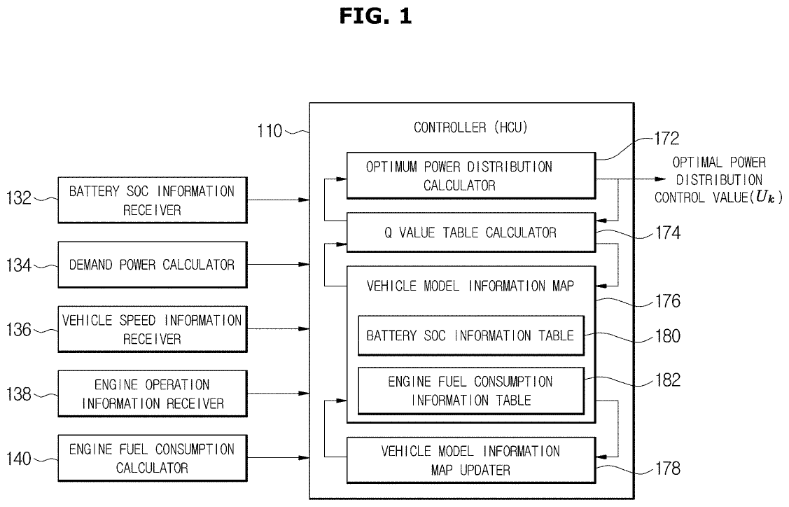

FIG. 1 is a view illustrating a control system of a hybrid vehicle according to exemplary embodiments of the disclosure. In FIG. 1, a controller (HCU; Hybrid Control Unit) 110 uses Q-learning technique of reinforcement learning in the field of machine learning based on vehicle state information to generate an optimal vehicle control value through learning.

As illustrated in FIG. 1, the controller 110 may receive state information of a hybrid vehicle from a battery SOC information receiver 132, a demand power calculator 134, a vehicle speed information receiver 136, an engine operation information receiver 138, and an engine fuel consumption calculator 140. The battery SOC information receiver 132, the requested power calculator 134, the vehicle speed information receiver 136, the engine operation information receiver 138, and the engine fuel consumption calculator 140 may be vehicle state information obtaining devices.

The battery SOC information receiver 132 may receive state of charger (SOC) information of a battery from a battery management system (BMS) that manages the battery, and may transmit the received SOC information to the controller 110.

The demand power calculator 134 may calculate a demand power of the hybrid vehicle based on information such as a detection signal of an accelerator pedal sensor (APS) of the hybrid vehicle and a vehicle speed, and may transmit the calculated requested power information to the controller 110. The demand power calculator 134 may calculate the demand power of the hybrid vehicle through driving state information and a vehicle parameter of the hybrid vehicle, as illustrated in Equation 1 below.

P_{dem}=v·(Fₗₒₛₛ+F_{accel}),F_{accel}=(Mᵥₑₕ+I_{eq}_·aᵥₑₕ,Fₗₒₛₛ=f₀+f₁×v+f₂×v₂<Equation 1>

P_{dem}: vehicle demand power

v: vehicle speed

Fₗₒₛₛ: vehicle drive loss force

F_{accel}: vehicle acceleration force

Mᵥₑₕ: vehicle weight

I_{eq}: vehicle powertrain equivalent inertia

aᵥₑₕ: vehicle acceleration

f₀, f₁, f₂: vehicle driving resistance coefficient

The vehicle speed information receiver 136 may receive information about a current speed of the hybrid vehicle and transmit the received speed information to the controller 110.

The engine operation information receiver 138 may receive real-time on/off state information of an engine and transmit the received on/off state information of the engine to the controller 110.

The engine fuel consumption calculator 140 may calculate the fuel consumption per hour of the engine when the engine is on, and may transmit the calculated fuel consumption information to the controller 110.

The controller 110 may include an optimum power distribution calculator 172, a Q value table calculator 174, a vehicle model information map 176, and a vehicle model information map updater 178. The vehicle model information map 176 may include a battery SOC information table 180 and an engine fuel consumption information table 182. The controller 110 may generate an optimal power distribution control value uₖ through learning using the Q-learning technique based on such device configuration (or logic). The generated optimal power distribution control value uₖ may be transmitted to a lower control system that controls the engine and a motor.

The optimum power distribution calculator 172 may calculate the optimal power distribution control value (control ratio) uₖ based on the engine and the motor on the basis of hybrid vehicle state information (battery SOC information, demand power, vehicle speed, engine on/off state information). Compute (derive) the optimal power distribution control value (control ratio) uₖ using a Q value table of the Q value table calculator 174.

The Q value table calculator 174 may update the values of the Q value table according to a predetermined algorithm. The Q value table may be updated by reflecting changes in the vehicle state information in two consecutive periods.

The vehicle model information map 176 may include the battery SOC information table 180 and the engine fuel consumption information table 182. The battery SOC information table 180 of the vehicle model information map 176 may store the battery SOC information and relationship data of a battery SOC output according to the demand power, the vehicle speed, and a control input. The engine fuel consumption information table 182 of the vehicle model information map 176 may store relationship data of engine power consumption determined by the demand power, the vehicle speed, the control input, and engine on/off information.

The vehicle model information map updater 178 may update data of the vehicle model information map 176 using driving information and the vehicle state information (battery SOC information, demand power, vehicle speed, engine on/off state information, and engine fuel consumption) of the hybrid vehicle. The vehicle model information map updater 178 may be updated by reflecting the changed driving information and the changed vehicle state information in two consecutive periods.

The controller 110 may discretize the measured and calculated values using the Nearest Neighbor method as illustrated in Equation 2, Equation 3, and Equation 4 to use the demand power, the vehicle speed, and the battery SOC, respectively.

P_{dem}∈{P_{dem}¹,P_{dem}², . . . ,P_{dem}^{N}^{ₚ}} <Equation 2>

v∈{v¹,v², . . . ,v^{N}^{ᵥ}} <Equation 3>

SOC∈{soc¹,soc², . . . ,soc^{N}^{_{soc}}} <Equation 4>

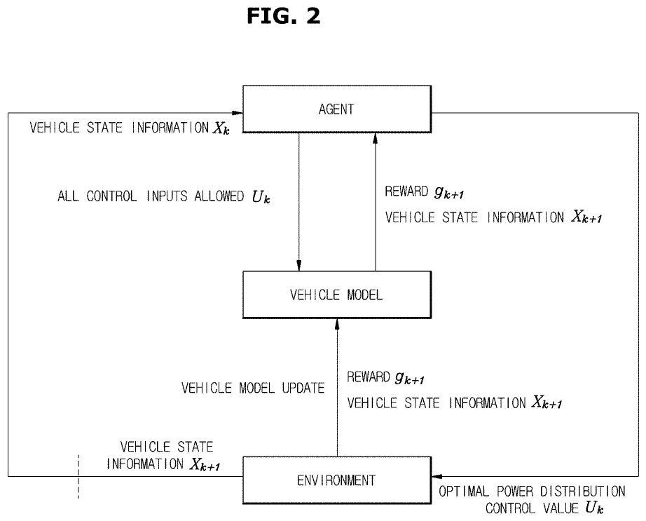

FIG. 2 is a view illustrating a concept for generating an optimal power distribution control value of a hybrid vehicle according to exemplary embodiments of the disclosure. That is, FIG. 2 illustrates a concept of generating the optimal vehicle control value through learning using the Q-learning technique of reinforcement learning in the field of machine learning based on the state information of the hybrid vehicle.

As illustrated in FIG. 2, the disclosure is characterized by optimizing the power distribution ratio of the engine and the motor through learning by applying an algorithm developed based on the Q-learning technique of reinforcement learning in the field of machine learning to power distribution of the hybrid vehicle.

To this end, a system configuration according to the embodiment of the disclosure may be largely composed of an agent, a vehicle model, and an environment. The agent is a subject that performs decision-making and learning, and may be the controller (HCU) 110 that is a higher control entity illustrated in FIG. 1 in the hybrid vehicle of the disclosure. The environment may be any component except the agent. For example, in the hybrid vehicle according to the embodiment, the environment may include the battery SOC information receiver 132, the demand power calculator 134, the vehicle speed information receiver 136, the engine operation information receiver 138, and engine fuel consumption calculator 140 illustrated in FIG. 1. In addition, although not illustrated in the drawing, the environment may include a lower control entity that receives control signals from the controller 110 and performs control of the hybrid vehicle, and the engine and the motor controlled by the lower control entity.

The agent may derive the optimal power distribution control value (control ratio) using the Q value table from the current driving state information and state variables of the hybrid vehicle. The Q value table may be a table approximating the value for each control input according to a vehicle driving situation. The agent may derive the optimal power distribution control value (control ratio) using the Q value table according to the driving state of the hybrid vehicle to optimize the power distribution control value (control ratio). In addition, the agent may derive target torque values of the engine and the motor by using the power distribution control value and demand power information.

The vehicle model may be a state information model of the hybrid vehicle, and is a table approximating the fuel consumption of the engine and a battery usage of the motor according to the selected optimal control value. The vehicle model may be updated using driving environment of the hybrid vehicle and measured values, thereby modeling an actual powertrain state of the hybrid vehicle.

In general Q-learning, the Q value table may be updated through the interaction between the agent and the environment. However, in the hybrid vehicle, the vehicle model (state information model) is used to improve the learning performance and real-time control performance of the controller 110.

The Q value table may be updated to reflect the trend of a driving speed profile of the hybrid vehicle through the interaction between the agent and the vehicle model. The agent may update the Q value table with a result obtained by inputting state variable information indicating the actual driving situation of the hybrid vehicle and virtual control input information to the vehicle model through the next state variable (+1) and reward (+1) of the hybrid vehicle.

In the hybrid vehicle, by repeating this process, the Q value table may be updated to derive the control input (power distribution ratio) optimized for the driving environment and powertrain state of the hybrid vehicle. The update period of the Q value table may be performed in real time or every preset period.

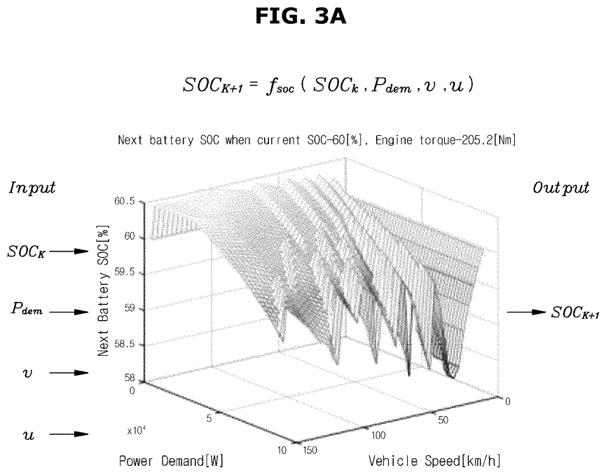

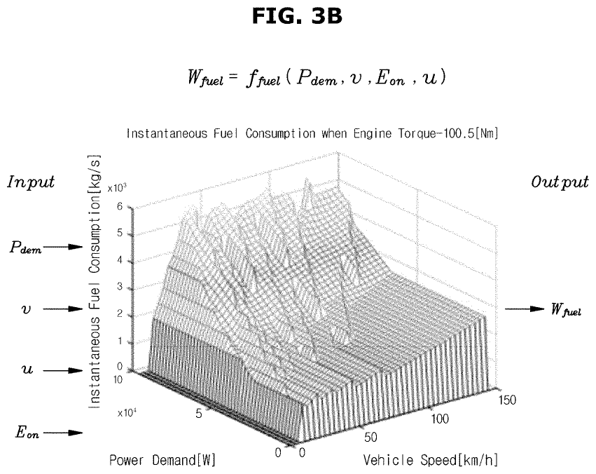

FIG. 3 illustrates a four-dimensional lookup table of each of the SOC information table 180 and the engine fuel consumption information table 182 stored in the vehicle model information map 176 of the controller (HCU) 110 according to exemplary embodiments of the disclosure. FIG. 3A is the SOC information table 180 and FIG. 3B is the engine fuel consumption information table 182.

As illustrated in FIG. 3A, the four-dimensional lookup table of the SOC information table 180 may be represented by Equation 5 below, and the four-dimensional lookup table of the engine fuel consumption information table 182 may be represented by Equation 6 below.

SOCₖ₊₁=f_{soc}(SOCₖ,P_{dem},v,u) <Equation 5>

f_{soc}: approximate model of battery SOC

u: power distribution control input (from previous cycle)

W_{fuel}=f_{fuel}(P_{dem},v,Eₒₙ,u) <Equation 6>

f_{fuel}: approximation model of engine fuel consumption

Eₒₙ: engine on/off state information

The optimization of the power distribution control value made in the controller 110 is made to minimize an overall cost function consisting of fuel consumption, battery charge/discharge, and engine on/off frequency limits, as illustrated in Equation 7 below.

$$minimize {J}_{π} ( {x}_{0} ) = {lim}_{N \to ∞} E \{ {\sum }_{k = 0}^{N - 1} {γ}^{k} g ( {x}_{k} , π ( {x}_{k} ) ) \} \\ g = {W}_{fuel} + β \cdot Δ {E}_{on} + ζ ( SOC ) , \\ ζ ( SOC ) = \{ \begin{matrix}ξ \cdot ( SOC - {SOC}_{ref} & if SOC > {SOC}_{min} \\ {C}_{Penalty} & if SOC \leq {SOC}_{min}\end{matrix} \qquad < Equation 7 >$$

J_{π}(x₀): total cost value (total cost value starting from initial value x0 and following control rule pi)

E: expected value

γ: discounted rate

g: instantaneous cost value

xₖ: state variables

π(xₖ): control rules based on the state variable Xk

β: engine on/off penalty constant

ΔEₒₙ: engine on/off state information

ζ(SOC): SOC value calculation function

SOC_{ref}: target SOC reference constant value

C_{Penalty}: penalty value when SOC is smaller than SOC minimum

ξ: weight constant value according to SOC regulation

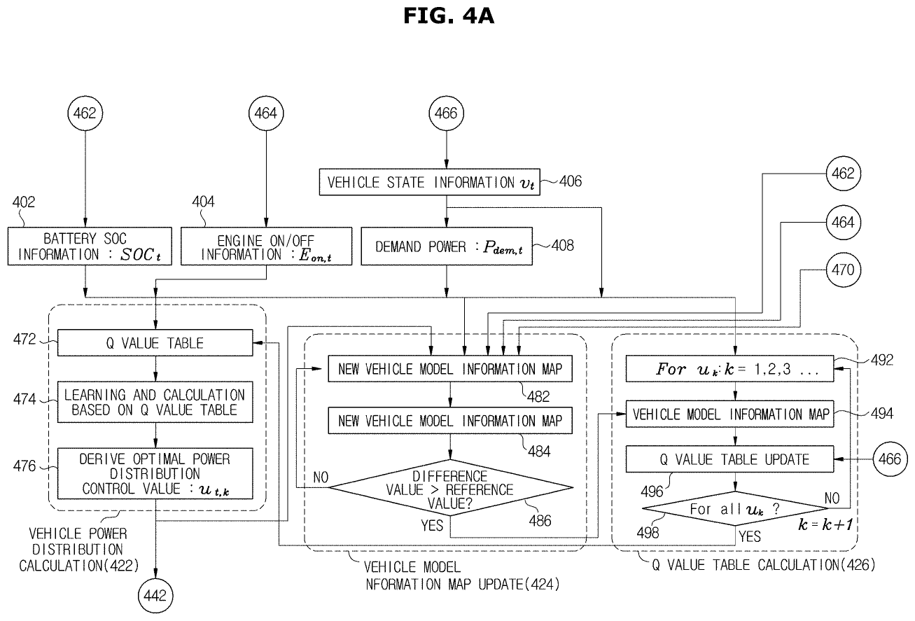

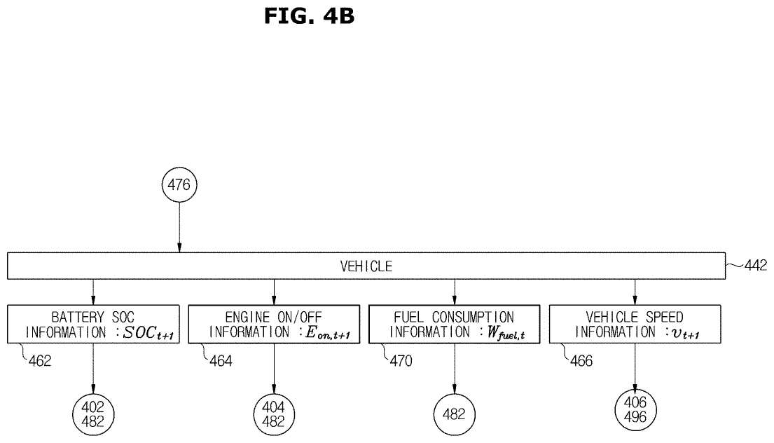

FIGS. 4A and 4B are views illustrating a control method for generating an optimal power distribution control value of a hybrid vehicle according to exemplary embodiments of the disclosure. In a control method illustrated in FIGS. 4A and 4B, the concept of generating the optimal vehicle control value through learning using the Q-learning technique of reinforcement learning illustrated in FIGS. 2 and 3 based on the device configuration illustrated in FIG. 1 was applied.

In FIGS. 4A and 4B, reference numerals 402, 404, 406, and 408 denote battery SOC information SOCₜ, engine on/off information E_{on,t}, demand power P_{dem,t}, and vehicle speed information vₜ, respectively. The battery SOC information SOCₜ, the engine on/off information E_{on,t}, the demand power P_{dem,t}, the vehicle speed information vₜ are parameter values in the current period (time) t at which the battery SOC information receiver 132, the engine operation information receiver 138, the demand power calculator 134, the vehicle speed information receiver 136, which have been described with reference to FIG. 1, have been received or calculated, respectively.

The battery SOC information SOCₜ, the engine on/off information E_{on,t}, the demand power P_{dem,t}, the vehicle speed information vₜ may be used for vehicle power distribution calculation 422, vehicle model information map update 424, and Q value table calculation 426. The vehicle power distribution calculation 422, the vehicle model information map update 424, and the Q value table calculation 426 of FIGS. 4A and 4B are respectively performed by the optimum power distribution calculator 172, the Q value table calculator 174, and the vehicle model information map updater 178 of the controller 110 described with reference to FIG. 1.

In the vehicle power distribution calculation 422, the optimum power distribution calculator 172 may calculate the optimal power distribution control value (control ratio) uₖ of the engine and motor based on hybrid vehicle state information (battery SOC information SOCₜ, engine on/off information E_{on,t}, demand power P_{dem,t}, vehicle speed information vₜ) by using a Q value table 472 secured through the Q value table calculation 426 of the Q value table calculator 174 (476).

In vehicle model information map update 424, a new vehicle mode map 482 may be obtained using the vehicle state information (battery SOC information, demand power, vehicle speed, engine on/off state information, engine fuel consumption) in two successive periods (e.g., t and t+1), and the vehicle model information map may be updated (484). When the difference value of the vehicle model information in two consecutive periods is greater than a preset reference value (YES in 486), the controller 110 may provide new vehicle model information to the vehicle model information map 484 of the Q value table calculation 426.

In Q value table calculation 426, the Q value table may be updated based on all control inputs (uₖ, k=1, 2, 3, . . . ) and the vehicle model information map (492, 494, and 496). When the update of the Q value table for all control inputs (uₖ, k=1, 2, 3, . . . ) is complete (YES in 498), the controller 110 may provide the updated Q value table in an operation of the vehicle power distribution calculation 422.

The optimal power distribution control value u_{t,k} derived through the vehicle power distribution calculation 422, the vehicle model information map update 424, and the Q value table calculation 426 may be transmitted to the lower control system for controlling the engine and the motor of the hybrid vehicle (442). The lower control system may perform appropriate power distribution control of the engine and the motor based on the received optimum power distribution control value u_{t,k} received.

In FIGS. 4A and 4B, reference numerals 462, 464, 470, and 466 denote battery SOC information SOCₜ₊₁, engine on/off information E_{on,t+1}, fuel consumption information W_{dem,t+1}, and vehicle speed information vₜ₊₁ at a next period (time) t+1, respectively. The battery SOC information SOCₜ₊₁, the engine on/off information E_{on,t+1}, the fuel consumption information W_{dem,t+1}, and the vehicle speed information vₜ₊₁ are parameter values in the next period (time) t+1 at which the battery SOC information receiver 132, the engine operation information receiver 138, the engine fuel consumption calculator 140, the vehicle speed information receiver 136, which have been described with reference to FIG. 1, have been received or calculated, respectively.

The battery SOC information SOCₜ₊₁, the engine on/off information E_{on,t+1}, the fuel consumption information W_{dem,t+1}, and the vehicle speed information vₜ₊₁ in the next period (time) t+1 may be used to derive the optimal power distribution control value u_{t+i,k} in the next period (time) t+1.

According to the exemplary embodiments of the disclosure, it provides the effect of generating optimal vehicle control values through learning using Q-learning technique of reinforcement learning in the field of machine learning based on vehicle status information.

The disclosed embodiments is merely illustrative of the technical idea, and those skilled in the art will appreciate that various modifications, changes, and substitutions may be made without departing from the essential characteristics thereof. Therefore, the exemplary embodiments disclosed above and the accompanying drawings are not intended to limit the technical idea, but to describe the technical spirit, and the scope of the technical idea is not limited by the embodiments and the accompanying drawings. The scope of protection shall be interpreted by the following claims, and all technical ideas within the scope of equivalent shall be interpreted as being included in the scope of rights.

What is claimed is:

1. A method of controlling a hybrid vehicle comprising:
obtaining vehicle state information including battery SOC information, engine on/off information, demand power, vehicle speed information, and fuel consumption information;
creating a vehicle model information map using the vehicle state information;
creating a Q value table based on the vehicle model information map; and
calculating power distribution control values of an engine and a motor through reinforcement learning based on the Q value table.

2. The method according to claim 1, wherein the reinforcement learning based on the Q value table is configured to calculate the power distribution control values using the vehicle state information generated in two consecutive periods as state and reward values, respectively.

3. The method according to claim 2, further comprising:
updating the vehicle model information map to reflect change contents in the vehicle state information;
updating the Q value table to reflect update contents of the vehicle model information map; and
performing calculation of the power distribution control values reflecting the changed contents of the vehicle state information by performing the reinforcement learning based on the updated Q value table.

4. The method according to claim 1, wherein the power distribution control values are values for minimizing energy consumption of the engine and the motor while satisfying the demand power.

5. A hybrid vehicle comprising:
a vehicle state information obtaining device configured to obtain vehicle state information including battery SOC information, engine on/off information, demand power, vehicle speed information, and fuel consumption information; and
a controller configured to:
create a vehicle model information map using the vehicle state information;
create a Q value table based on the vehicle model information map; and
calculate power distribution control values of an engine and a motor through reinforcement learning based on the Q value table.

6. The hybrid vehicle according to claim 5, wherein the reinforcement learning based on the Q value table is configured to calculate the power distribution control values using the vehicle state information generated in two consecutive periods as state and reward values, respectively.

7. The hybrid vehicle according to claim 6, wherein the controller is configured to:
update the vehicle model information map to reflect change contents in the vehicle state information;
update the Q value table to reflect update contents of the vehicle model information map; and
perform calculation of the power distribution control values reflecting the changed contents of the vehicle state information by performing the reinforcement learning based on the updated Q value table.

8. The hybrid vehicle according to claim 5, wherein the power distribution control values are values for minimizing energy consumption of the engine and the motor while satisfying the demand power.

9. The hybrid vehicle according to claim 5, wherein the controller comprises a power distribution calculator, a Q value table calculator, a vehicle model information map, and a vehicle model information map updater.

10. The hybrid vehicle according to claim 9, wherein the power distribution calculator is configured to calculate the power distribution control values of the engine and the motor based on the vehicle state information using the Q value table of the Q value table calculator.

11. The hybrid vehicle according to claim 9, wherein the Q value table calculator is configured to update values of the Q value table according to a predetermined algorithm.

12. The hybrid vehicle according to claim 9, wherein the vehicle model information map comprises a battery SOC information table and an engine fuel consumption information table.

13. The hybrid vehicle according to claim 12, wherein the battery SOC information table is configured to store relationship data between the battery SOC information, the demand power, and a battery SOC output according to the vehicle speed.

14. The hybrid vehicle according to claim 12, wherein the engine fuel consumption information table is configured to store relationship data between an engine fuel consumption amount determined according to the demand power, the vehicle speed, and the engine on/off information.

15. The hybrid vehicle according to claim 9, wherein the vehicle model information map updater is configured to update data of the vehicle model information map using the changed driving information of the hybrid vehicle and the changed vehicle state information.
